(19) United States
(12) Patent Application Publication
(10) Pub. No.: US 2014/0059304 A1
(43) Pub. Date: Feb. 27, 2014

(54) SEMICONDUCTOR MEMORY DEVICE

(71) Applicant: KABUSHIKI KAISHA TOSHIBA, Tokyo (JP)

(72) Inventors: Takayuki Iwai, Tokyo (JP); Makoto Takahashi, Yokohama-shi (JP)

(73) Assignee: KABUSHIKI KAISHA TOSHIBA, Tokyo (JP)

(21) Appl. No.: 13/835,299

(22) Filed: Mar. 15, 2013

(30) Foreign Application Priority Data
Aug. 22, 2012 (JP) 2012-183382

(51) Int. Cl. G06F 12/00

(52) U.S. Cl. CPC G06F 12/00
USPC 711/154

(57) ABSTRACT

According to one embodiment, a semiconductor memory device includes a memory core, a peripheral circuit which executes a reading/writing of data in the memory core, and an interface which inputs a control signal for the reading/writing. The control signal inputs by one data path. The peripheral circuit is configured to read a first data from a first address in the memory core in a first cycle, and read a second data from a second address in the memory core in parallel with writing a third data to a third address in the memory core in a second cycle.

### CROSS-REFERENCE TO RELATED APPLICATIONS

This application is based upon and claims the benefit of priority from Japanese Patent Application No. 2012-183382, filed Aug. 22, 2012, the entire contents of which are incorporated herein by reference.

### FIELD

Embodiments described herein relate generally to a semiconductor memory device.

### BACKGROUND

In recent years, with the progress of video technology, an improvement in throughput of a system using a semiconductor memory device such as DRAM for use such as a large-capacity image buffer is becoming increasingly important. However, when, for example, a read modify write operation is performed, there is a significant degradation in throughput in a semiconductor memory device incapable of performing read and write operations simultaneously. Moreover, in a semiconductor memory device capable of performing read and write operations simultaneously, two systems are needed for each of command and address input and data input/output, increasing the chip size and the number of terminals in the interface.

### BRIEF DESCRIPTION OF THE DRAWINGS

FIG. 1 is a diagram showing a semiconductor memory device;

FIG. 2 is a diagram showing a first embodiment;

FIG. 3 is a diagram exemplifying a memory cell;

FIG. 4 is a diagram showing specifications of an interface;

FIG. 5 is a diagram showing a memory core and peripheral circuit;

FIG. 6 is a diagram showing a read/write data path inside the memory core;

FIG. 7 is a diagram showing a memory core and peripheral circuit;

FIG. 8 is a diagram showing a read/write data path inside the memory core;

FIG. 9 is a diagram showing a second embodiment;

FIG. 10 is a diagram showing a memory core and peripheral circuit;

FIG. 11 is a diagram showing a modification of the first embodiment;

FIG. 12 is a diagram showing a modification of the second embodiment;

FIG. 13 is a diagram showing a third embodiment;

FIG. 14 is a diagram showing a fourth embodiment;

FIG. 15 is a diagram showing a fifth embodiment;

FIG. 16 is a diagram exemplifying a bank configuration;

FIG. 17 is a diagram showing specifications of an interface;

FIG. 18 is a diagram showing a memory core and peripheral circuit; and

FIG. 19 is a diagram showing a read/write data path inside the memory core.

### DETAILED DESCRIPTION

In general, according to one embodiment, a semiconductor memory device comprises: a memory core; a peripheral circuit which executes a reading/writing of data in the memory core; and an interface which inputs a control signal for the reading/writing. The control signal is input through one data path. The peripheral circuit is configured to: read a first data from a first address in the memory core in a first cycle, and read a second data from a second address in the memory core in parallel with writing a third data to a third address in the memory core in a second cycle.

The embodiments will be described below with reference to the drawings.

In a semiconductor memory device capable of performing read and write operations simultaneously, two systems are needed for input of control signals such as commands. When, for example, a read modify write operation is performed, it is necessary to provide each of terminals to input a control signal for reading and terminals to input a control signal for writing in the interface.

Thus, the following embodiments propose a technology to automatically do reading/writing in parallel when, for example, a control signal instructs a mode (first mode) to perform a read modify write operation by integrating paths to input control signals for reading/writing into one system and providing the system in the interface.

That is, when the control signal instructs the first mode, first data is read from a first address in the memory core in the first cycle and in the second cycle following the first cycle, second data is read from a second address in the memory core and in parallel therewith, third data is written to a third address in the memory core.

A semiconductor memory device capable of improving throughput without increasing the chip size and the number of terminals in the interface can thereby be realized.

A semiconductor memory device (for example, DRAM) according to an embodiment may constitute a chip as a general-purpose memory or IP (Intellectual property) adopted in a microcomputer or system LSI.

Therefore, if the semiconductor memory device is a chip, the terminal in the interface means, for example, a pad on the chip or a pin of a package and if the semiconductor memory device is an IP, the terminal in the interface means, for example, a node of a conductive wire.

### [Semiconductor Memory Device]

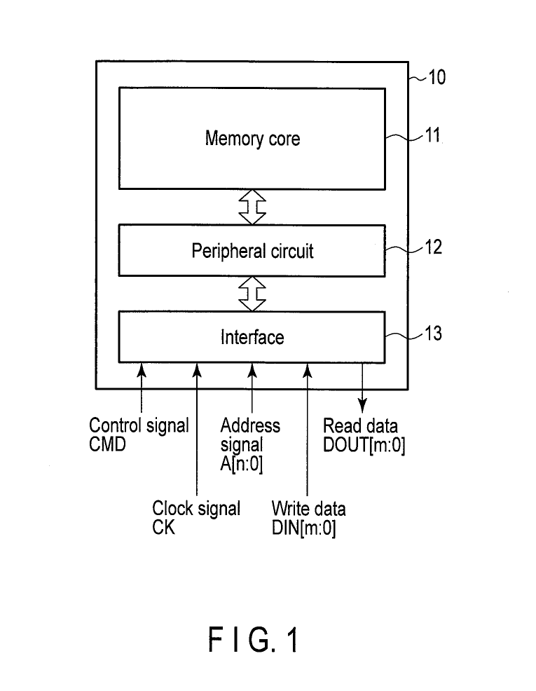

FIG. 1 shows a semiconductor memory device.

Semiconductor memory device (for example, DRAM) 10 includes a memory core 11, a peripheral circuit 12, and an interface 13.

The memory core 11 includes memory cells that store data. The peripheral circuit 12 executes reading/writing of data from/to the memory core 11.

Control signal CMD for reading/writing, clock signal CK to control read/write operation timing, and address signals A[n:0] to specify an address in the memory core 11 intended for reading/writing are input into the interface 13.

Read data DOUT[m:0] is output from interface 13 and write data DIN[m:0] is input into interface 13.

A[n:0] means (n+1)-bit address signals A[n], A[n−1], . . . A[0]. DOUT[m:0] means (m+1)-bit read data DOUT[m], DOUT[m−1], . . . DOUT[0]. DIN[m:0] means (m+1)-bit write data DIN[m], DIN[m−1], . . . DIN[0].

Here, n and m are both natural numbers.

The peripheral circuit 12 reads first data from a first address in memory core 11 in the first cycle and in the second cycle following the first cycle, reads second data from a second address in the memory core 11 and in parallel therewith, writes third data to a third address in the memory core 11.

Each of the first, second, and third addresses includes row and column addresses. The row and column addresses of the third address are the same as the row and column addresses of the first address.

According to the above configuration, data is already read from the first address in the first cycle and thus, the first (third) address can be overwritten with data in the second cycle, which improves throughput.

When a control signal instructs a read modify write operation, read and write operations are automatically performed in parallel in the second cycle. If, for example, the column address of the third address is generated based on the column address of the first address inside the peripheral circuit 12, such a parallel operation can be realized.

Therefore, a semiconductor memory device capable of improving throughput without increasing the chip size and the number of terminals in the interface can be realized.

### First Embodiment

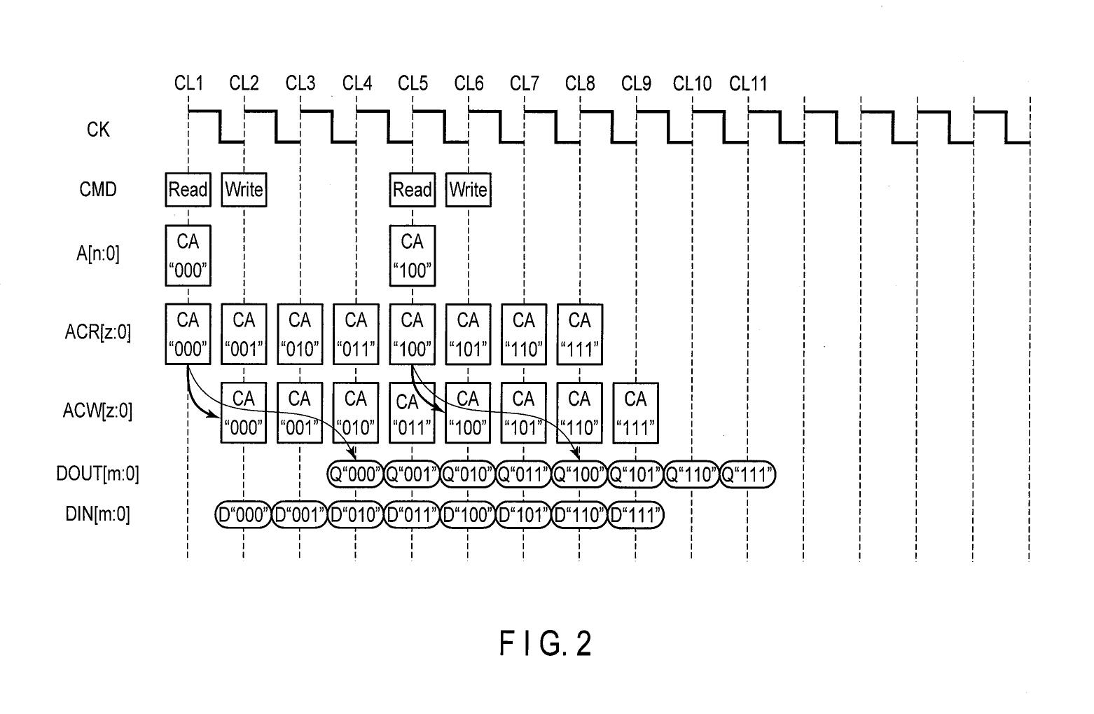

FIG. 2 shows an operation according to the first embodiment.

The operation regarding read and write operations is performed by using the semiconductor memory device in FIG. 1.

FIG. 2 assumes that the burst length is 4 and the read latency is 3. To do output of read data DOUT[m:0] and input of write data DIN[m:0] in parallel, regarding the data path, for example, a read data line and a write data line are provided separately (two systems are provided). Regarding control signal CMD and address signal A[n:0], a common line is used for read and write operations (integration into one system).

For example, the read operation is performed successively from first cycle CL1 to fourth cycle CL4.

In first cycle CL1, column address CA“000” of address signal A[n:0] is latched into a first address latch unit and is also output as read column address signal ACR[z:0] to read data from the memory cell at column address CA“000”. Data Q“000” read in first cycle CL1 is output to the outside in fourth cycle CL4.

Read column address signal ACR[z:0] in first cycle CL1 is latched into a second address latch unit to be used as write column address signal ACW[z:0] in the next cycle (second cycle CL2) of first cycle CL1.

In second cycle CL2, for example, column address CA“001” is generated by an address counter based on column address CA“000” latched into the first address latch unit and is also output as read column address signal ACR[z:0] to read data from the memory cell at column address CA“001”.

In parallel therewith, for example, column address CA“000” latched into the second address latch unit is output as write column address signal ACW[z:0] in first cycle CL1 to write data D“000” to the memory cell at column address CA“000”.

Read column address signal ACR[z:0] in second cycle CL2 is latched into the second address latch unit to be used as write column address signal ACW[z:0] in the next cycle (third cycle CL3) of second cycle CL2.

Data Q“001” read in second cycle CL2 is output to the outside in fifth cycle CL5.

Similarly, third and fourth cycles CL3, CL4 are executed.

In fifth cycle CL5, column address CA“100” of address signal A[n:0] is latched into the first address latch unit and is also output as read column address signal ACR[z:0] to read data from the memory cell at column address CA“100”.

In parallel therewith, for example, column address CA“011” latched into the second address latch unit is output as write column address signal ACW[z:0] to write data D“011” to the memory cell at column address CA“011”.

Read column address signal ACR[z:0] in fifth cycle CL5 is latched into the second address latch unit to be used as write column address signal ACW[z:0] in the next cycle (sixth cycle CL6) of fifth cycle CL5.

Data Q“100” read in fifth cycle CL5 is output to the outside in eighth cycle CL8.

Similarly, sixth to ninth cycles CL6 to CL9 are executed.

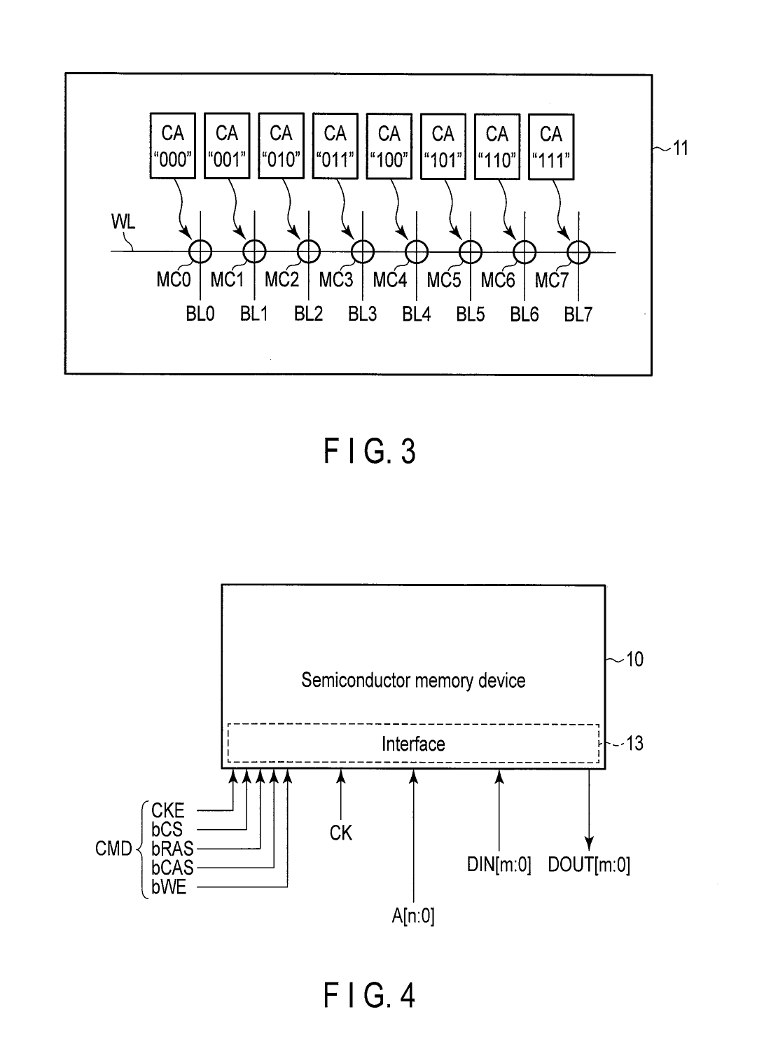

FIG. 3 exemplifies the memory cell for which the operation in FIG. 2 is intended.

Memory cells MC0 to MC7 for which the operation in FIG. 2 is intended are connected, for example, to common word line WL and also to mutually different bit lines BL0 to BL7. That is, row addresses of memory cells MC0 to MC7 are the same and column addresses CA“000” to CA“111” of memory cells MC0 to MC7 are different.

However, the target of operation in FIG. 2 is not limited to such a memory cell.

For example, the operation in FIG. 2 can also be applied when, like a memory cell array having banks described later, data at a specified address is read and written to an address that is different from the specified address.

FIG. 4 shows specifications of an interface.

Two systems of data paths are provided in the interface 13 of the semiconductor memory device 10 to do output of read data DOUT[m:0] and input of write data DIN[m:0] in parallel. Accordingly, an improvement in throughput is achieved.

Regarding control signal CMD and address signal A[n:0], input paths thereof are integrated into one system to reduce the number of terminals in the interface.

In the present embodiment, for example, input paths of clock enable signal CKE, chip select signal bCS, row address/strobe signal bRAS, column address/strobe signal bCAS, and write enable signal bWE as control signals CMD are integrated into one system.

CK is a clock signal to control read/write timing in the semiconductor memory device 10.

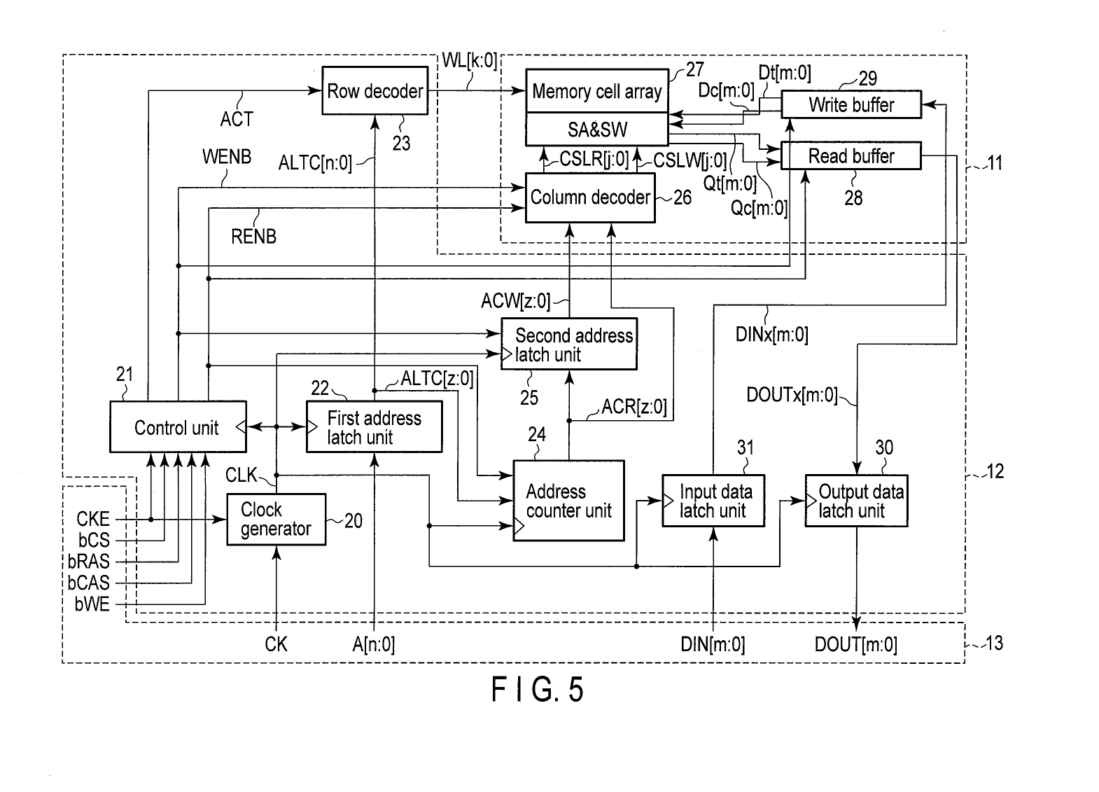

FIG. 5 shows a semiconductor memory device 10, a memory core 11, and a peripheral circuit 12 shown in FIG. 1.

FIG. 5 is a block diagram that realizes specifications in FIG. 2. Clock signal CK is input into a clock generator 20 and the clock generator 20 generates an internal clock signal CLK. Control signal (CKE, bCS, bRAS, bCAS, bWE) CMD is input into a control unit (command control) 21 in synchronization with internal clock signal CLK.

The control unit 21 controls the operation of each circuit block inside the memory core 11 and the peripheral circuit 12 based on the control signal CMD.

A first address latch unit 22 latches address signal (first address) A[n:0] from the interface 13 in synchronization with internal clock signal CLK. Address signal A[n:0] contains a row address and a column address.

When activation signal ACT from the control unit 21 is active, a row decoder 23 outputs drive signal WL[k:0] to drive one of word lines in a memory cell array 27 based on address signal ALTC[n:0] latched into the first address latch unit 22.

An Address counter unit 24 functions as a read address counter. The address counter unit 24 successively generates read column signal ACR[z:0] used in cycles according to the burst length.

For example, when read enable signal RENB from the control unit 21 is enabled, the address counter unit 24 generates read column address signal (column address of the first address) ACR[z:0] based on address signal ALTC[z:0] latched into the first address latch unit 22.

Read column address signal ACR[z:0] is input into a column decoder 26 to select the memory cell to be read in, for example, first cycle CL1. When read enable signal RENB is enabled, the column decoder 26 outputs column selection signal CSLR[j:0] to select the memory cell to be read based on read column address signal ACR[z:0].

A second address latch unit 25 functions as a write address latch. The second address latch unit 25 latches read column address signal ACR[z:0] generated by the address counter unit 24 in synchronization with internal clock signal CLK in, for example, first cycle CL1.

Also, the second address latch unit 25 outputs read column address signal ACR[z:0] latched in first cycle CL1 as write column address signal ACW[z:0] to select the memory cell to be written to in, for example, second cycle CL2 following first cycle CL1.

Write column address signal ACW[z:0] is input into the column decoder 26. When write enable signal WENB is enabled, the column decoder 26 outputs column selection signal CSLW[j:0] to select the memory cell to be written to based on write column address signal ACW[z:0].

A column selection switch SW is turned on/off by column selection signal CSLR[j:0], CSLW[j:0] and a sense amplifier SA functions as a buffer of read data/write data. The column selection switch SW and The sense amplifier SA will be described later.

Read data Qt[m:0], Qc[m:0] from memory cell array 27 is input into a read buffer 28. Read data DOUTx[m:0] from the read buffer 28 is transferred to an output data latch unit 30. The output data latch unit 30 outputs read data DOUT[m:0] outside of the semiconductor memory device through the interface 13 in synchronization with internal clock signal CLK.

Write data DIN[m:0] is input into an input data latch unit 31 from outside the semiconductor memory device through the interface 13 in synchronization with internal clock signal CLK. Write data DINx[m:0] from the input data latch unit 31 is transferred to a write buffer 29. Write data Dt[m:0], Dc[m:0] from the write buffer 29 is input into a memory cell array 27.

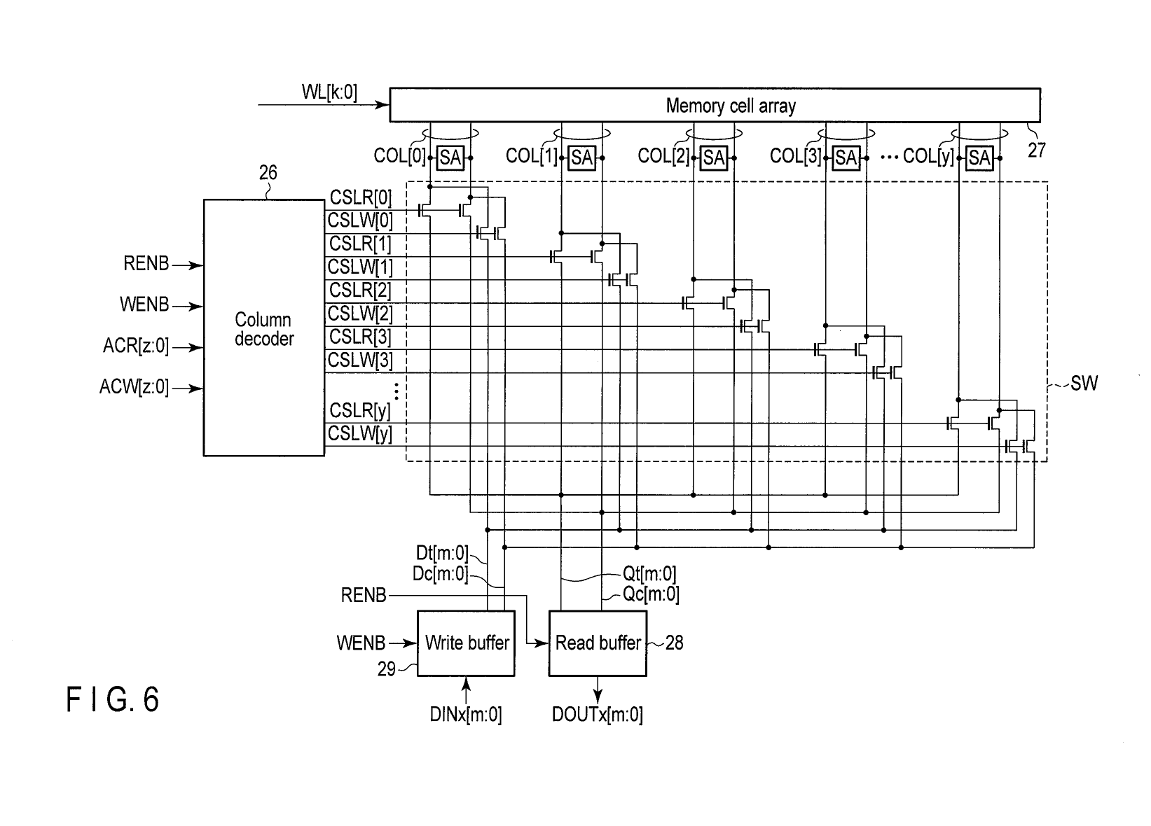

FIG. 6 shows the column selection switch SW and the sense amplifier SA in FIG. 5.

In the present embodiment, two systems are provided as data transfer paths between the sense amplifier SA and the read/write buffers 28, 29.

That is, read data Qt[m:0], Qc[m:0] is the input into read buffer 28 from the sense amplifier SA through the column selection switch SW in all column addresses COL[0], COL[1], . . . COL[y].

When, for example, only a read operation is performed in some cycle, if column selection signal CSLR[0] is “H (high level)” and remaining column selection signals CSLR[1] to CSLR[y] are “L (low level)”, read data Qt[m:0], Qc[m:0] of column address COL[0] is the input into read buffer 28 from the sense amplifier SA through the column selection switch SW.

At this point, all column selection signals CSLW[0], CSLW[1], . . . CSLW[y] for writing are “L”.

Similarly, write data Dt[m:0], Dc[m:0] is input into the sense amplifier SA from the write buffer 29 through the column selection switch SW in all column addresses COL[0], COL[1], . . . COL[y].

When, for example, only a write operation is performed in some cycle, if column selection signal CSLW[0] is “H (high level)” and remaining column selection signals CSLW[1] to CSLW[y] are “L (low level)”, write data Dt[m:0], Dc[m:0] of column address COL[0] is input into the sense amplifier SA from the write buffer 29 through the column selection switch SW.

At this point, all column selection signals CSLR[0], CSLR[1], . . . CSLR[y] for reading are “L”.

According to the above configuration, two systems are provided as data transfer paths and thus, for example, the sense amplifier SA at column address COL[0] can selectively be connected to the write buffer 29 in parallel with selective connection of the sense amplifier SA at column address COL[1] to the read buffer 28 by setting column selection signals CSLR[1], CSLW[0] to “H” in, for example, second cycle CL2 after first cycle CL1.

In the present embodiment, read data Qt[m:0], Qc[m:0] is represented as complementary data (2 bits) and write data Dt[m:0], Dc[m:0] is represented as complementary data (2 bits), but the present embodiment is not limited to such an example.

The read buffer 28 is activated when read enable signal RENB is enabled and the write buffer 29 is activated when write enable signal WENB is enabled.

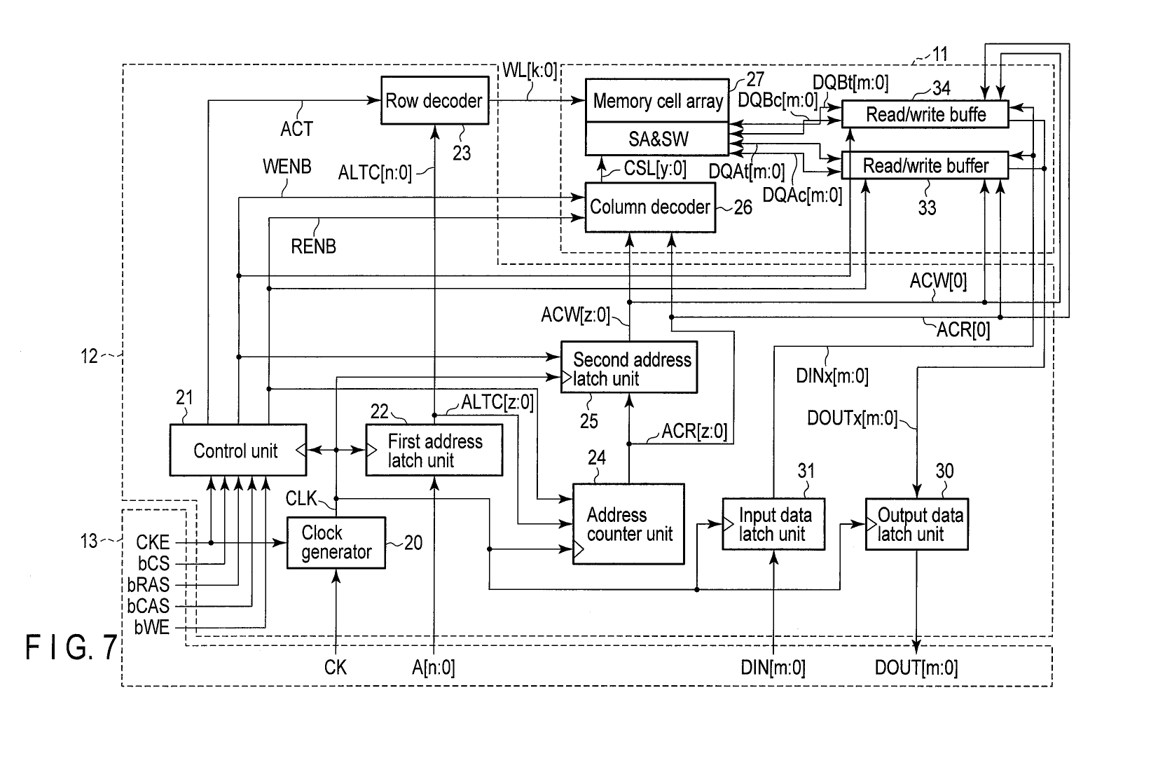

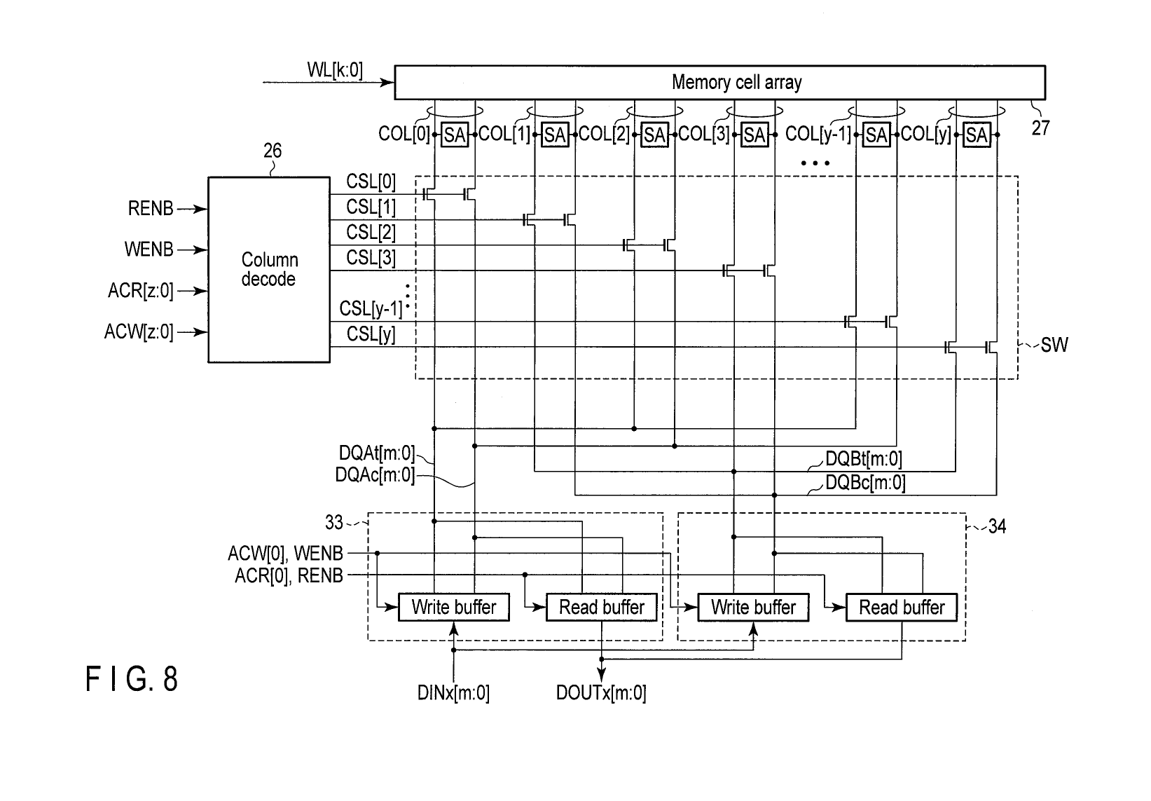

FIGS. 7 and 8 show a modification of FIGS. 5 and 6.

FIG. 7 is a block diagram corresponding to FIG. 5 and FIG. 8 is a block diagram corresponding to FIG. 6. FIGS. 7 and 8 are different from FIGS. 5 and 6 in data transfer paths between the sense amplifier read/write buffers. Otherwise, both are the same. Therefore, the same reference numerals are attached to the same components and a detailed description thereof is omitted.

In the present modification, regarding even-numbered column addresses COL[0], COL[2], . . . of column addresses COL[0], COL[1], . . . COL[y], the sense amplifier SA is connected to a read/write buffer 33. Regarding odd-numbered column addresses COL[1], COL[3], . . . of column addresses COL[0], COL[1], . . . COL[y], the sense amplifier SA is connected to a read/write buffer 34.

That is, at even-numbered column addresses COL[0], COL[2], . . . , read/write data DQAt[m:0], DQAc[m:0] is transferred between the sense amplifier SA and the read/write buffer 33.

If, for example, column selection signal CSL[0] of even-numbered column selection signals is “H” and remaining column selection signals CSL[2], . . . are “L”, read/write data DQAt[m:0], DQAc[m:0] at column address COL[0] is transferred between the sense amplifier SA and the read/write buffer 33.

Similarly, at odd-numbered column addresses COL[1], COL[3], . . . , read/write data DQBt[m:0], DQBc[m:0] is transferred between the sense amplifier SA and the read/write buffer 34.

If, for example, column selection signal CSL[1] of odd-numbered column selection signals is “H” and remaining column selection signals CSL[3], . . . are “L”, read/write data DQBt[m:0], DQBc[m:0] at column address COL[1] is transferred between the sense amplifier SA and the read/write buffer 34.

According to the above configuration, two read/write buffers 33, 34 are present and thus, for example, the sense amplifier SA at column address COL[0] can selectively be connected to a write buffer in the read/write buffer 33 in parallel with selective connection of the sense amplifier SA at column address COL[1] to a read buffer in the read/write buffer 34 by setting column selection signals CSL[0], CSL[1] to “H” in, for example, second cycle CL2 after first cycle CL1.

Whether to activate the read buffer or the write buffer in read/write buffers 33, 34 can be controlled based on lowest-order bits ACR[0], ACW[0] of column address signal ACR[z:0], ACW[z:0].

For example, as is evident from FIG. 2, lowest-order bit ACR[0] of ACR[z:0] is “1” and lowest-order bit ACW[0] of ACW[z:0] is “0” in second cycle CL2. That is, ACR[0] and ACW[0] change in each cycle and one of ACR[0] and ACW[0] is “1” and the other is “0” in each cycle.

Thus, for example, when ACR[0] is “0”, the read buffer in the read/write buffer 33 is activated and when ACR[0] is “1”, the read buffer in the read/write buffer 34 is activated.

Also, for example, when ACW[0] is “0”, the write buffer in the read/write buffer 33 is activated and when ACW[0] is “1”, the write buffer in the read/write buffer 34 is activated.

Specifications in FIG. 2 can thereby be realized.

In the present embodiment, read/write data DQAt[m:0], DQAc[m:0] is represented as complementary data (2 bits) at even-numbered column addresses COL[0], COL[2], . . . , but the present embodiment is not limited to such an example. Also, read/write data DQBt[m:0], DQBc[m:0] is represented as complementary data (2 bits) at odd-numbered column addresses COL[1], COL[3] but the present embodiment is not limited to such an example.

The read buffer in read/write buffers 33, 34 is activated when read enable signal RENB is enabled and the write buffer in read/write buffers 33, 34 is activated when write enable signal WENB is enabled.

### Second Embodiment

In the first embodiment described above, for example, data is read from column address CA“000” in first cycle CL1 and data is written to column address CA“000” in second cycle CL2 following first cycle CL1.

However, the write operation does not necessarily have to be performed in second cycle CL2. That is, the write operation to column address CA“000” may be performed in any cycle of the second cycle and subsequent cycles.

Thus, in the second embodiment, a case when, for example, data is read from column address CA“000” in first cycle CL1 and data is written to column address CA“000” in third cycle CL3, which is two cycles after first cycle CL1, will be described.

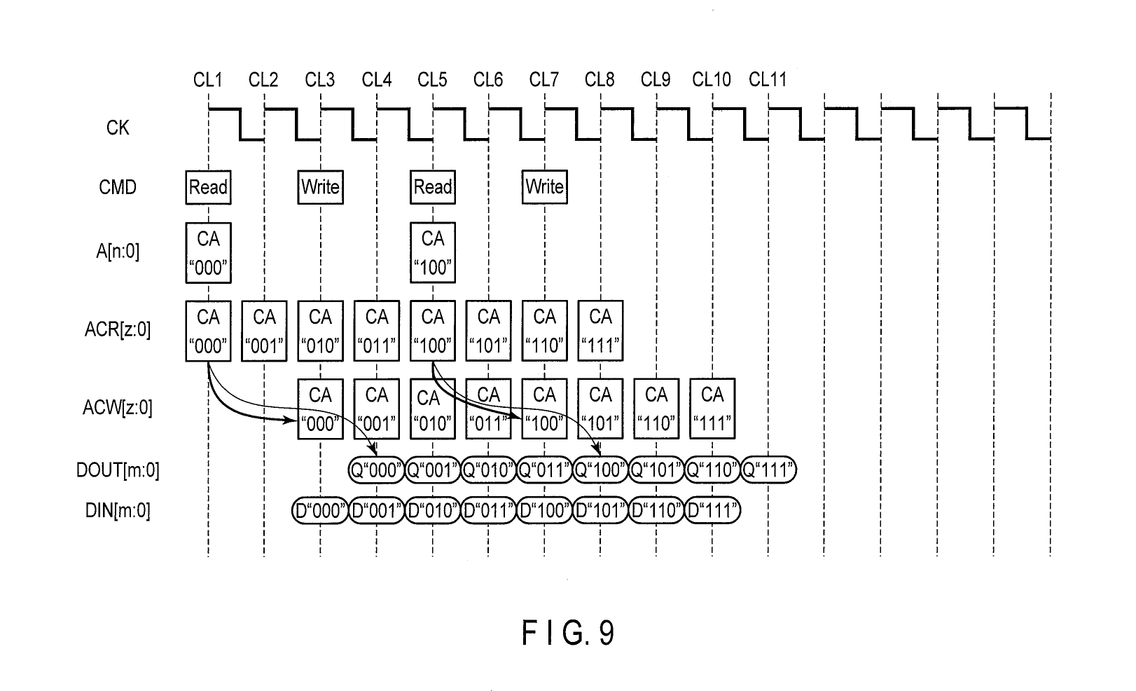

FIG. 9 shows the operation according to the second embodiment.

The operation is performed by using the semiconductor memory device in FIG. 1.

FIG. 9 also assumes that the burst length is 4 and the read latency is 3 like in the first embodiment.

For example, the read operation is performed successively from first cycle CL1 to fourth cycle CL4.

In first cycle CL1, column address CA“000” of address signal A[n:0] is latched into a first address latch unit and is also output as read column address signal ACR[z:0] to read data from the memory cell at column address CA“000”. Data Q“000” read in first cycle CL1 is output to the outside in fourth cycle CL4.

Read column address signal ACR[z:0] in first cycle CL1 is latched into a second address latch unit to be used as write column address signal ACW[z:0] in the cycle (third cycle CL3) two cycles after first cycle CL1.

In second cycle CL2, for example, column address CA“001” is generated by an address counter based on column address CA“000” latched into the first address latch unit and is also output as read column address signal ACR[z:0] to read data from the memory cell at column address CA“001”. Data Q“001” read in second cycle CL2 is output to the outside in fifth cycle CL5.

Read column address signal ACR[z:0] in second cycle CL2 is latched into the second address latch unit to be used as write column address signal ACW[z:0] in the cycle (fourth cycle CL4) two cycles after second cycle CL2.

In third cycle CL3, for example, column address CA“010” is generated by the address counter based on column address CA“000” latched into the first address latch unit and is also output as read column address signal ACR[z:0] to read data from the memory cell at column address CA“010”.

In parallel therewith, for example, column address CA“000” latched into the second address latch unit is output as write column address signal ACW[z:0] to write data D“000” to the memory cell at column address CA“000”.

Read column address signal ACR[z:0] in third cycle CL3 is latched into the second address latch unit to be used as write column address signal ACW[z:0] in the cycle (fifth cycle CL5) two cycles after third cycle CL3.

Data Q“010” read in third cycle CL3 is output to the outside in sixth cycle CL6.

Examples of the memory cell to be targets of the operation in FIG. 9 are the same as, for example, in FIG. 3 and examples of specifications of the interface for the operation in FIG. 9 are the same as in FIG. 4 and thus, descriptions thereof are omitted.

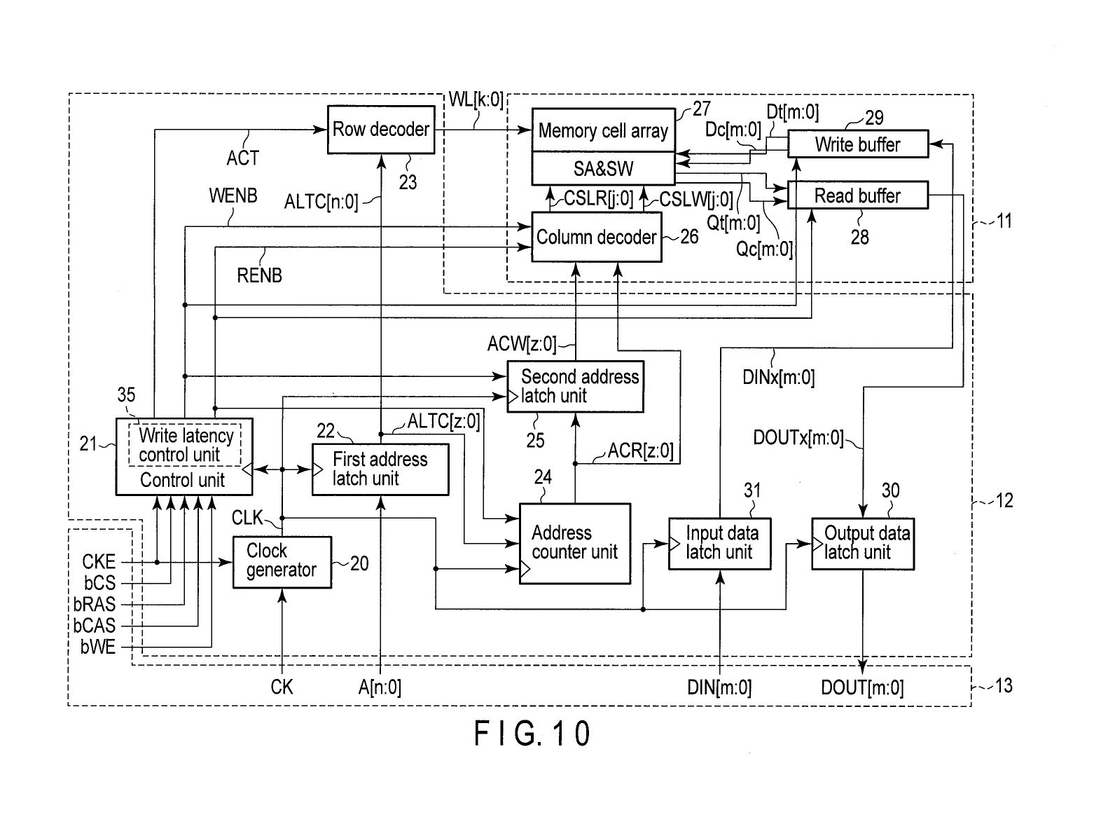

FIG. 10 shows the semiconductor memory device 10, memory core 11, and the peripheral circuit 12 shown in FIG. 1.

FIG. 10 corresponds to FIG. 5. FIG. 10 is different from FIG. 5 in configuration of a control unit 21 only. That is, the control unit 21 includes a write latency control unit 35 in the present embodiment. The write latency control unit 35 decides the timing to output write column address ACW[z:0] from a second address latch unit 25 and also decides the timing to output write enable signal WENB from the control unit 21.

In FIG. 10, the configuration other than the control unit 21 is the same as in FIG. 5 and thus, the description here is omitted.

A column selection switch SW and a sense amplifier SA in FIG. 10 are, like, for example, in the first embodiment, as shown in FIG. 6. Also in the present embodiment, like in the first embodiment, data transfer paths as shown in FIGS. 7 and 8 can be modified.

### Third Embodiment

In the first and second embodiments described above, for example, the write column address is automatically generated based on the read column address inside (peripheral circuit) a semiconductor memory device.

However, the write column address does not necessarily have to be automatically generated inside a semiconductor memory device. That is, the write column address may be input, like the read column address, from outside the semiconductor memory device via an interface.

Thus, in the third embodiment, a case when, for example, the write column address is input from outside the semiconductor memory device will be described.

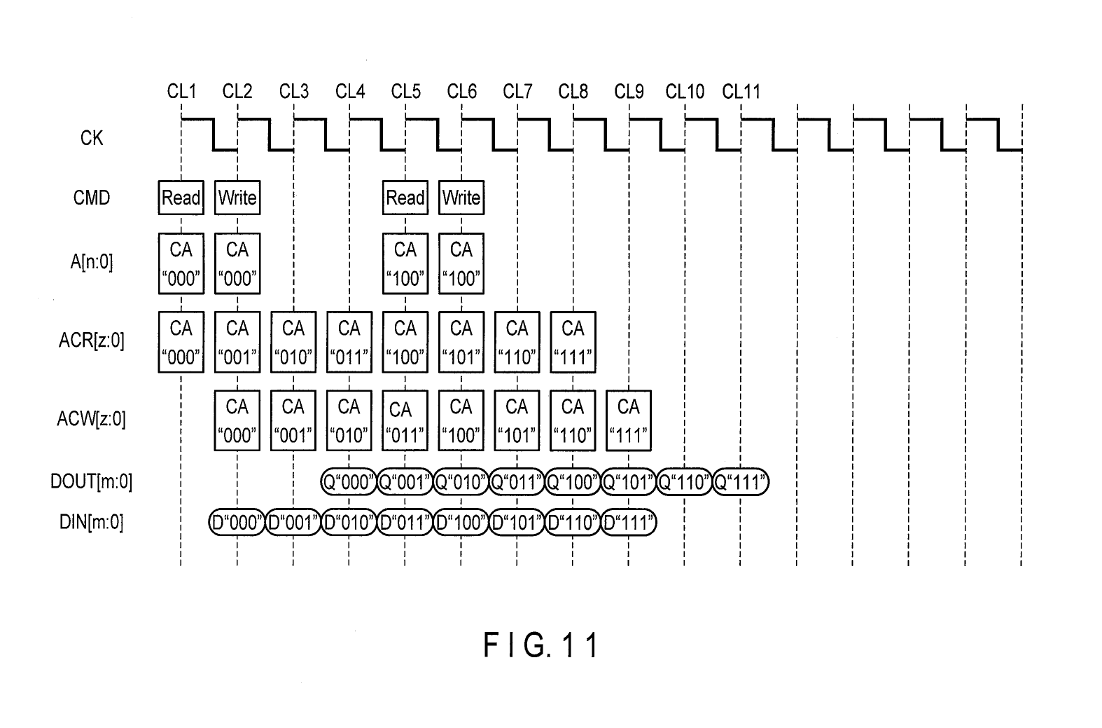

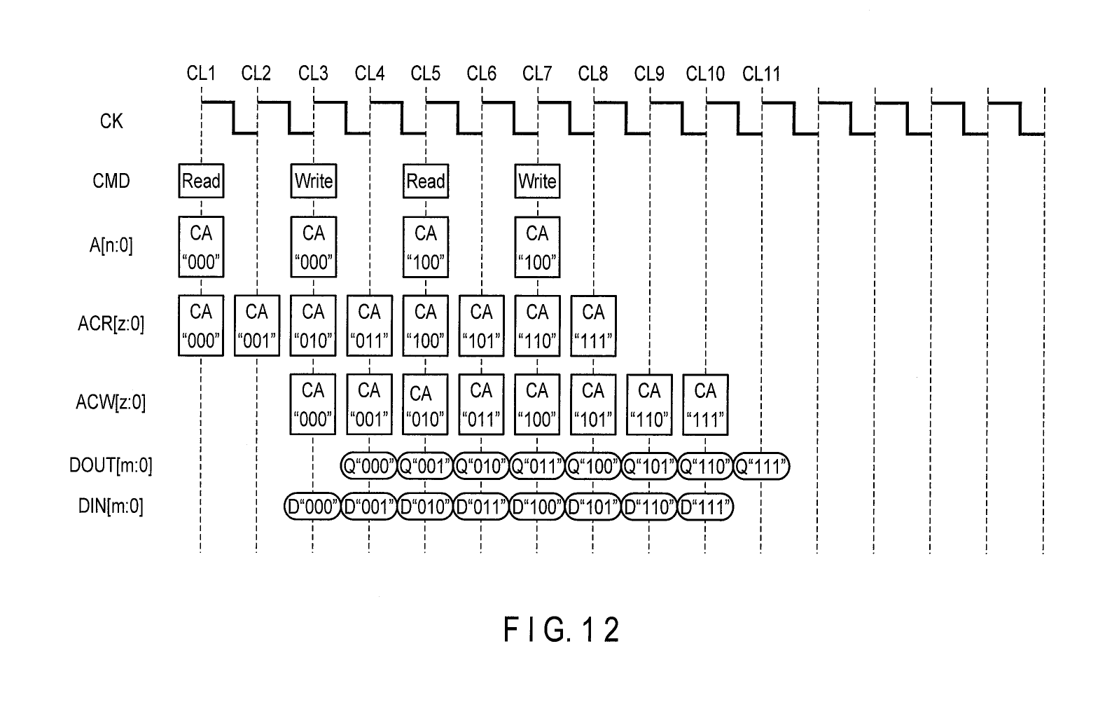

Operation specifications will be as shown in FIGS. 11 and 12.

FIG. 11 corresponds to the operation specifications in the first embodiment (FIG. 2) and FIG. 12 corresponds to the operation specifications in the second embodiment (FIG. 9).

When compared with FIGS. 2 and 9, FIGS. 11 and 12 are characterized in that the write column address is input, like the read column address, from outside the semiconductor memory device via the interface. Otherwise, FIGS. 11 and 12 are the same as FIGS. 2 and 3 and thus, the description here is omitted.

A circuit example to realize the operation specifications will be described below.

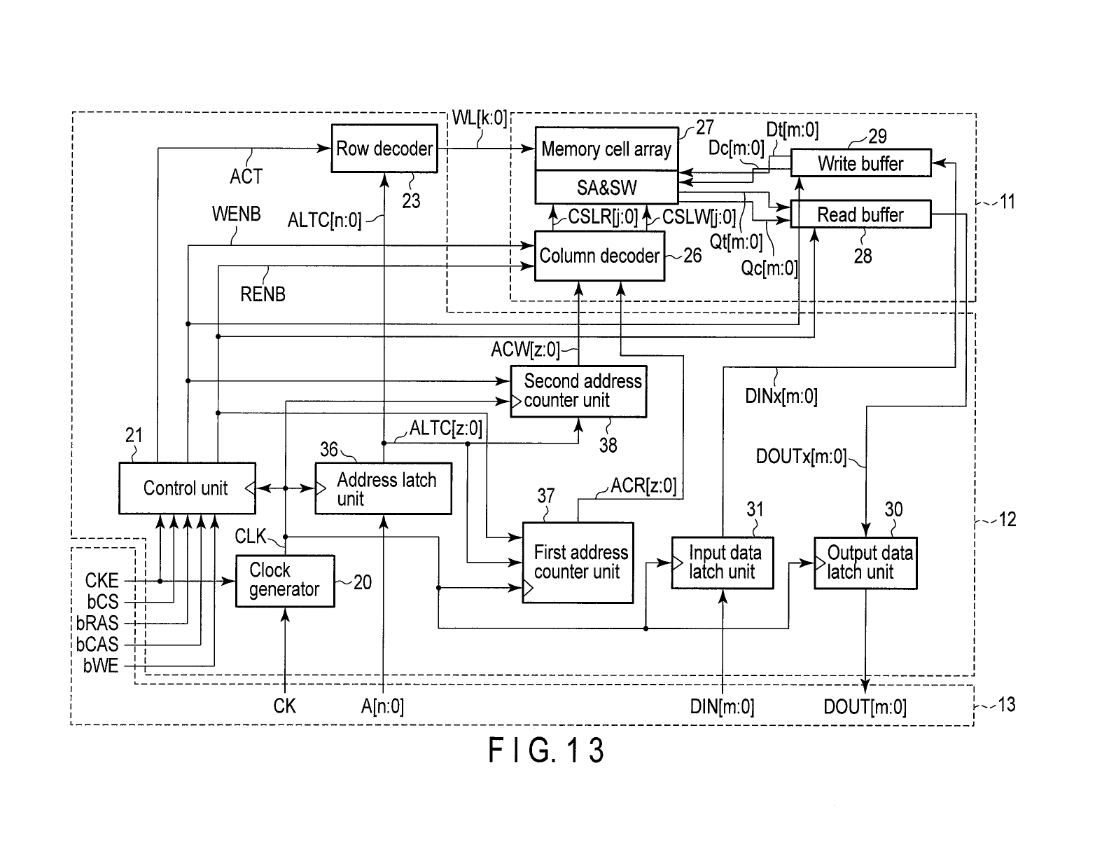

FIG. 13 shows the semiconductor memory device 10, the memory core 11, and the peripheral circuit 12 shown in FIG. 1.

FIG. 13 is a block diagram that realizes specifications in FIG. 11 or FIG. 12. Clock signal CK is input into a clock generator 20 and the clock generator 20 generates an internal clock signal CLK. Control signal (CKE, bCS, bRAS, bCAS, bWE) CMD is input into a control unit (command control) 21 in synchronization with internal clock signal CLK.

The control unit 21 controls the operation of each circuit block inside the memory core 11 and the peripheral circuit 12 based on the control signal CMD.

An address latch unit 36 latches address signal A[n:0] from the interface 13 in synchronization with internal clock signal CLK. Address signal A[n:0] contains a row address and a column address.

When activation signal ACT from the control unit 21 is active, a row decoder 23 outputs drive signal WL[k:0] to drive one of word lines in a memory cell array 27 based on address signal ALTC[n:0] latched into the address latch unit 36.

A first address counter unit 37 functions as a read address counter. The first address counter unit 37 successively generates read column signal ACR[z:0] used in cycles according to the burst length.

For example, when read enable signal RENB from the control unit 21 is enabled, the first address counter unit 37 generates read column address signal ACR[z:0] based on address signal ALTC[z:0] latched into the address latch unit 36.

Read column address signal ACR[z:0] is input into a column decoder 26 to select the memory cell to be read in, for example, first cycle CL1. When read enable signal RENB is enabled, a column decoder 26 outputs column selection signal CSLR[j:0] to select the memory cell to be read based on read column address signal ACR[z:0].

A second address counter unit 38 functions as a write address counter. The second address counter unit 38 successively generates write column signal ACW[z:0] used in cycles according to the burst length.

For example, when write enable signal WENB from the control unit 21 is enabled, the second address counter unit 38 generates write column address signal ACW[z:0] based on address signal ALTC[z:0] latched into the address latch unit 36.

Write column address signal ACW[z:0] is input into the column decoder 26 to select the memory cell to be written to in, for example, second cycle CL2. When write enable signal WENB is enabled, the column decoder 26 outputs column selection signal CSLW[j:0] to select the memory cell to be written to based on write column address signal ACW[z:0].

A column selection switch SW is turned on/off by column selection signal CSLR[j:0], CSLW[j:0] and a sense amplifier SA functions as a buffer of read data/write data.

Read data Qt[m:0], Qc[m:0] from memory cell array 27 is input into a read buffer 28. Read data DOUTx[m:0] from the read buffer 28 is transferred to an output data latch unit 30. The output data latch unit 30 outputs read data DOUT[m:0] outside of the semiconductor memory device through the interface 13 in synchronization with internal clock signal CLK.

Write data DIN[m:0] is input into an input data latch unit 31 from outside the semiconductor memory device through the interface 13 in synchronization with internal clock signal CLK. Write data DINx[m:0] from the input data latch unit 31 is transferred to a write buffer 29. Write data Dt[m:0], Dc[m:0] from the write buffer 29 is input into a memory cell array 27.

Examples of the memory cell in the memory cell array 27 are the same as, for example, in FIG. 3 and examples of specifications of the interface are the same as, for example, in FIG. 4.

The column selection switch SW and the sense amplifier SA are, like, for example, in the first embodiment, as shown in FIG. 6. Also in the present embodiment, like in the first embodiment, data transfer paths as shown in FIGS. 7 and 8 can be modified.

### Fourth Embodiment

The fourth embodiment relates to a combination of the above first or second embodiment and the above third embodiment. That is, in the present embodiment, for example, a mode in which the write column address is automatically generated inside the semiconductor memory device and a mode in which the write column address is input from outside the semiconductor memory device via an interface are switched.

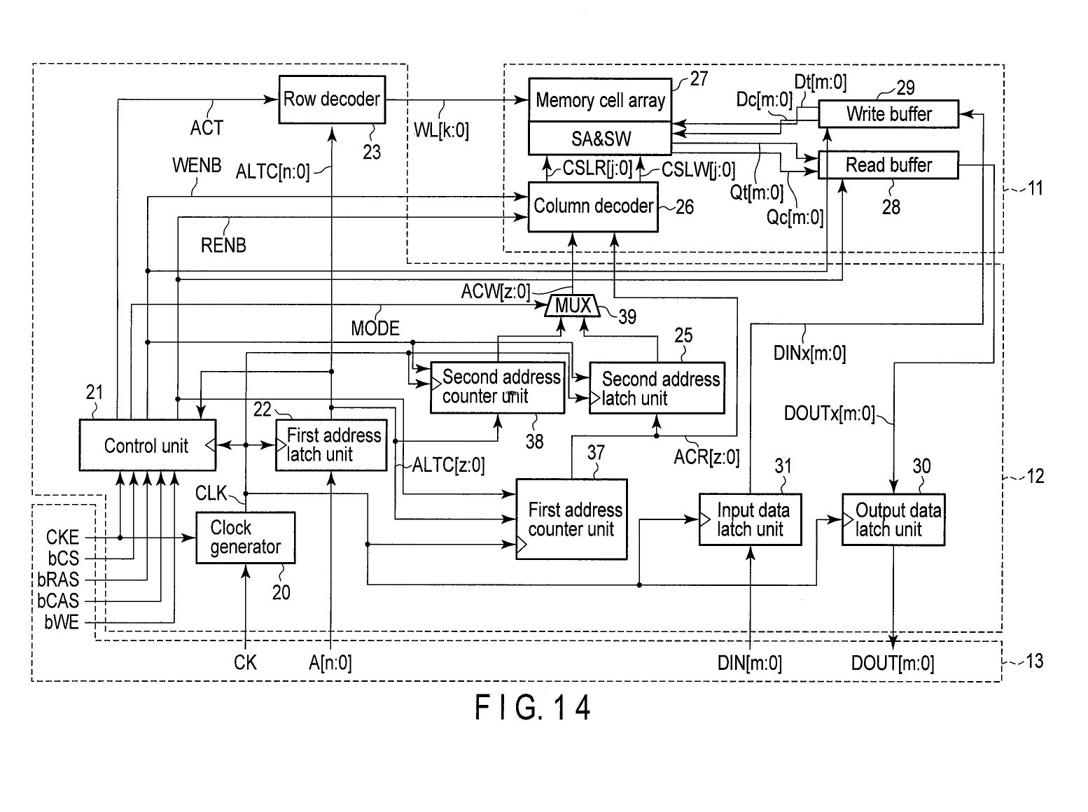

FIG. 14 shows the semiconductor memory device 10, the memory core 11, and the peripheral circuit 12 shown in FIG. 1.

Clock signal CK is input into a clock generator 20 and the clock generator 20 generates an internal clock signal CLK. Control signal (CKE, bCS, bRAS, bCAS, bWE) CMD is input into a control unit (command control) 21 in synchronization with internal clock signal CLK.

The control unit 21 controls the operation of each circuit block inside the memory core 11 and the peripheral circuit 12 based on the control signal CMD.

A first address latch unit 22 latches address signal A[n:0] from the interface 13 in synchronization with internal clock signal CLK. Address signal A[n:0] contains a row address and a column address.

When activation signal ACT from the control unit 21 is active, row decoder 23 outputs drive signal WL[k:0] to drive one of word lines in a memory cell array 27 based on address signal ALTC[n:0] latched into the first address latch unit 22.

A first address counter unit 37 functions as a read address counter. The first address counter unit 37 successively generates read column signal ACR[z:0] used in cycles according to the burst length.

For example, when read enable signal RENB from the control unit 21 is enabled, the first address counter unit 37 generates read column address signal ACR[z:0] based on address signal ALTC[z:0] latched into the first address latch unit 22.

Read column address signal ACR[z:0] is input into a column decoder 26 to select the memory cell to be read in, for example, first cycle CL1. When read enable signal RENB is enabled, the column decoder 26 outputs column selection signal CSLR[j:0] to select the memory cell to be read based on read column address signal ACR[z:0].

The control unit 21 outputs mode signal MODE that switches the mode in which write column address ACW[z:0] is automatically generated inside the semiconductor memory device and the mode in which write column address ACW[z:0] is input from outside by control signal CMD and address signal ALTC[z:0].

When the control unit 21 instructs the mode in which write column address ACW[z:0] is automatically generated inside the semiconductor memory device, a second address latch unit 25 functions as a write address latch.

In this case, the second address latch unit 25 latches read column address signal ACR[z:0] generated by a first address counter unit 37 in synchronization with internal clock signal CLK in, for example, first cycle CL1.

Also, the second address latch unit 25 outputs read column address signal ACR[z:0] latched in first cycle CL1 as write column address signal ACW[z:0] to select the memory cell to be written to in, for example, second cycle CL2 following first cycle CL1.

When the control unit 21 instructs the mode in which write column address ACW[z:0] is input from outside the semiconductor memory device, an second address counter unit 38 functions as a write address counter.

In this case, the second address counter unit 38 successively generates write column signal ACW[z:0] used in cycles according to the burst length.

For example, when write enable signal WENB from the control unit 21 is enabled, the second address counter unit 38 generates write column address signal ACW[z:0] based on address signal ALTC[z:0] latched into the first address latch unit 22.

Then, a multiplexer (MUX) 39 transfers one of write column address signal ACW[z:0] from the second address latch unit 25 and write column address signal ACW[z:0] from the second address counter unit 38 to the column decoder 26 based on mode selection signal MODE from the control unit 21.

When write enable signal WENB is enabled, a column decoder 26 outputs column selection signal CSLW[j:0] to select the memory cell to be written to based on write column address signal ACW[z:0].

A column selection switch SW is turned on/off by column selection signal CSLR[j:0], CSLW[j:0] and a sense amplifier SA functions as a buffer of read data/write data.

Read data Qt[m:0], Qc[m:0] from a memory cell array 27 is input into a read buffer 28. Read data DOUTx[m:0] from the read buffer 28 is transferred to an output data latch unit 30. The Output data latch unit 30 outputs read data DOUT[m:0] outside of the semiconductor memory device through the interface 13 in synchronization with internal clock signal CLK.

Write data DIN[m:0] is input into an input data latch unit 31 from outside the semiconductor memory device through the interface 13 in synchronization with internal clock signal CLK. Write data DINx[m:0] from the input data latch unit 31 is transferred to a write buffer 29. Write data Dt[m:0], Dc[m:0] from the write buffer 29 is input into a memory cell array 27.

### Fifth Embodiment

In the first to fourth embodiments described above, a case when, for example, the read column address in first cycle CL1 and the write column address in second cycle CL2 are the same (for example, the read modify write operation) has been described.

However, the read column address in first cycle CL1 and the write column address in second cycle CL2 do not necessarily have to be the same.

Thus, in the present embodiment, an example in which the memory core in the semiconductor memory device includes banks and a read operation and a write operation are performed in different banks will be described. In this case, for example, the read column address (bank address) in first cycle CL1 and the write column address (band address) in second cycle CL2 are mutually different.

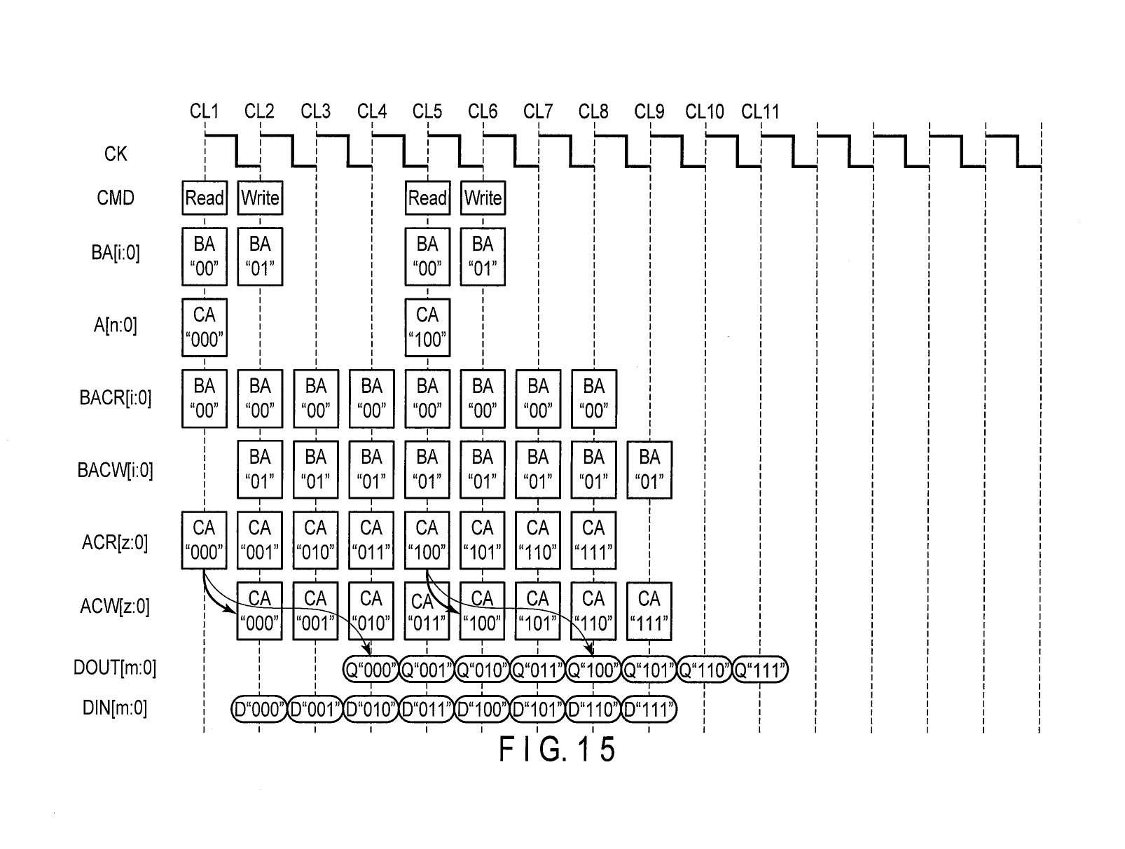

FIG. 15 shows the operation according to the fifth embodiment.

The operation is performed by using the semiconductor memory device in FIG. 1.

FIG. 15 assumes that the burst length is 4 and the read latency is 3. To do output of read data DOUT[m:0] and input of write data DIN[m:0] in parallel, regarding the data path, for example, a read data line and a write data line are provided separately (two systems are provided). Regarding control signal CMD and address signal A[n:0], a common line is used for read and write operations (integration into one system).

For example, the read operation is performed successively from first cycle CL1 to fourth cycle CL4.

In first cycle CL1, band address signal BA[i:0] is latched into a first address latch unit and is also output as read bank column address signal BACR[i:0] to select the bank at bank address BA“00”.

Also, column address CA“000” of address signal A[n:0] is latched into the first address latch unit and is also output as read column address signal ACR[z:0] to read data from the memory cell at column address CA“000” inside bank address BA“00”. Data Q“000” read in first cycle CL1 is output to the outside in fourth cycle CL4.

Read column address signal ACR[z:0] in first cycle CL1 is latched into a second address latch unit to be used as write column address signal ACW[z:0] in the next cycle (second cycle CL2) of first cycle CL1.

In second cycle CL2, for example, column address CA“001” is generated by an address counter based on column address CA“000” latched into the first address latch unit and is also output as read column address signal ACR[z:0] to read data from the memory cell at column address CA“001” inside bank address BA“00”.

In parallel therewith, bank address BA“01” input from outside is output as write bank address signal BACW[i:0] to select the bank at bank address BA“01”.

Also, for example, column address CA“000” latched into the second address latch unit is output as write column address signal ACW[z:0] to write data D“000” to the memory cell at column address CA“000” inside bank address BA“01”.

Read column address signal ACR[z:0] in second cycle CL2 is latched into the second address latch unit to be used as write column address signal ACW[z:0] in the next cycle (third cycle CL3) of second cycle CL2.

Data Q“001” read in second cycle CL2 is output to the outside in fifth cycle CL5.

Similarly, third and fourth cycles CL3, CL4 are executed.

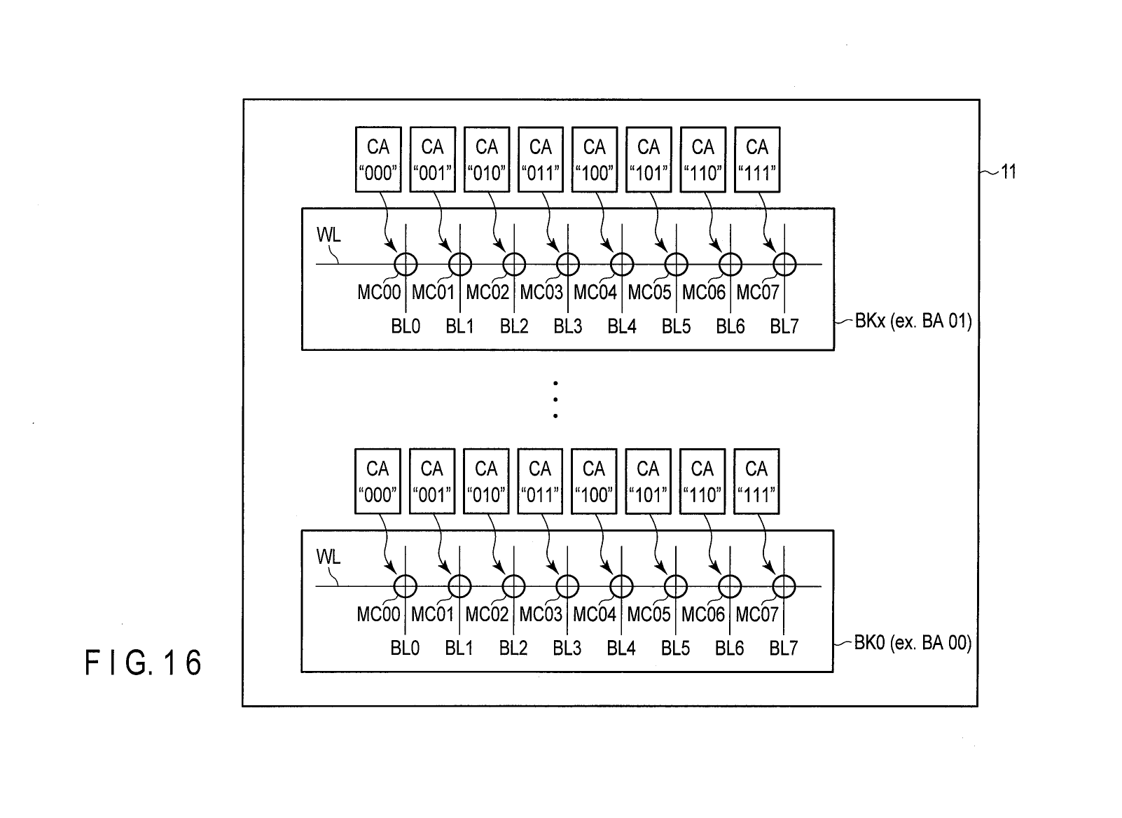

FIG. 16 exemplifies a bank configuration to be a target of the operation in FIG. 15.

In the operation according to the present embodiment, data at an address inside first bank BK0 (for example, bank address BA00) is read and data is written to an address inside second bank BKx (for example, bank address BA01).

Therefore, as shown in FIG. 16, memory cells MC00 to MC07 to be the target of the read operation in FIG. 15 are connected to, for example, word line WL inside first bank BK0 and memory cells MC00 to MC07 to be the target of the write operation in FIG. 15 are connected to, for example, word line WL inside second bank BKx.

That is, memory cells MC00 to MC07 to be the target of the read operation and memory cells MC00 to MC07 to be the target of the write operation have, for example, different bank addresses and the same row address and the same column address.

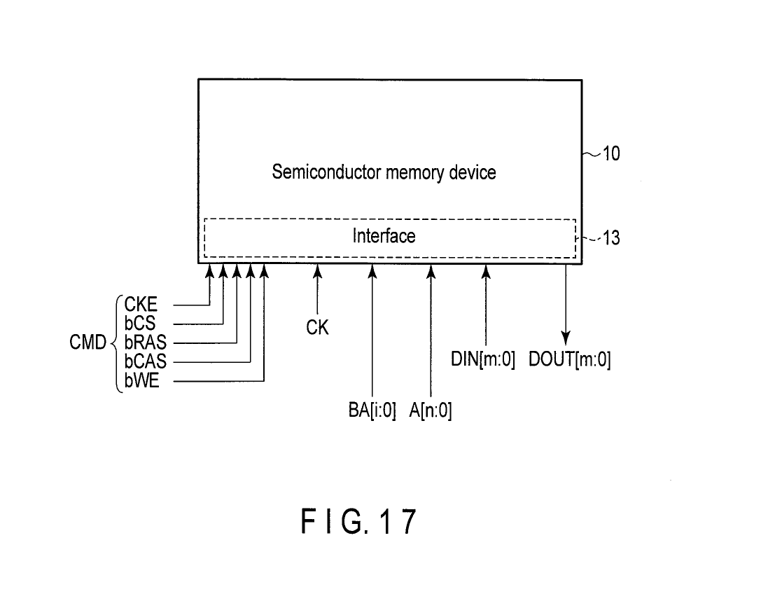

FIG. 17 shows specifications of an interface.

When compared with specifications in FIG. 4, specifications in the present embodiment are different in that bank address signal BA[i:0] is input into a semiconductor memory device 10 via an interface 13.

Two systems of data paths are provided in the interface 13 of the semiconductor memory device 10 to do output of read data DOUT[m:0] and input of write data DIN[m:0] in parallel. Accordingly, an improvement in throughput is achieved.

Regarding control signal CMD and address signal A[n:0], input paths thereof are integrated into one system to reduce the number of terminals in the interface.

In the present embodiment, for example, input paths of clock enable signal CKE, chip select signal bCS, row address/strobe signal bRAS, column address/strobe signal bCAS, and write enable signal bWE as control signals CMD are integrated into one system.

Further, a path to input bank address signal BA[i:0] to select the bank intended for reading/writing is provided.

CK is a clock signal to control read/write timing in semiconductor memory device 10.

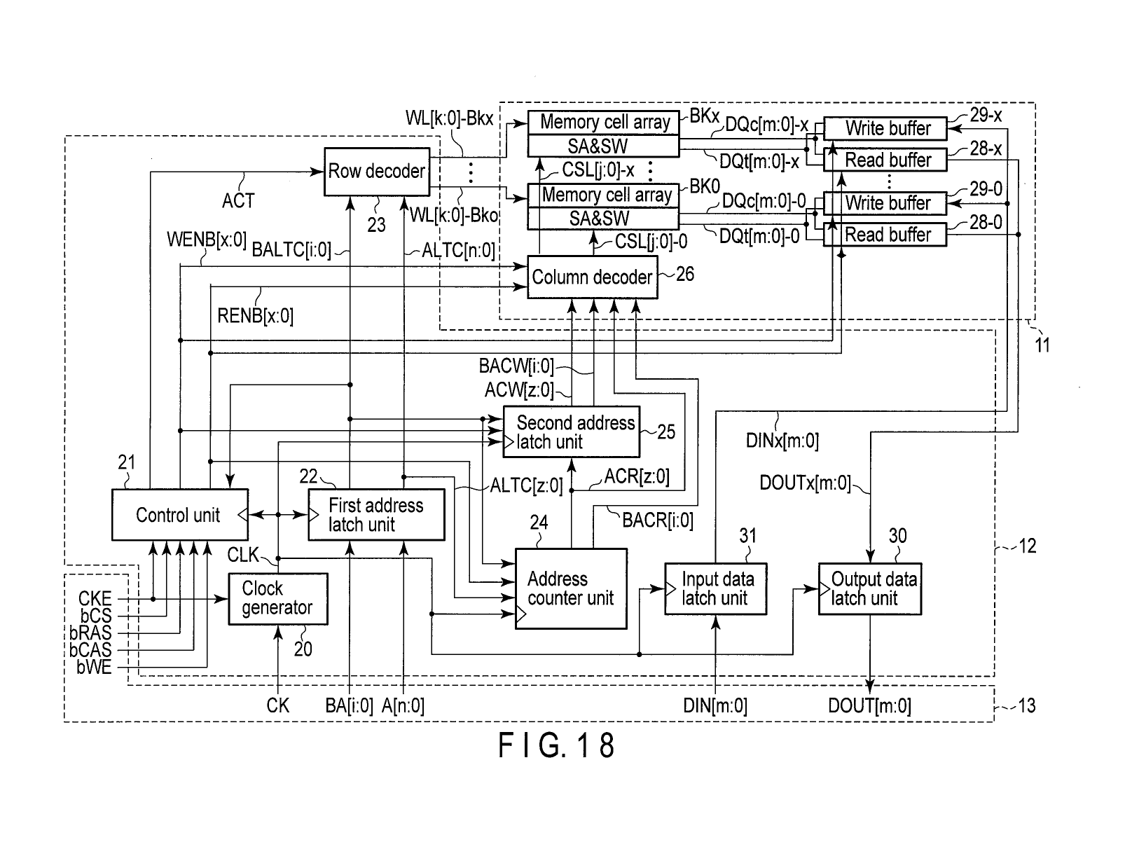

FIG. 18 shows a semiconductor memory device 10, a memory core 11, and a peripheral circuit 12 shown in FIG. 1.

FIG. 18 is a block diagram that realizes specifications in FIG. 15. Clock signal CK is input into a clock generator 20 and the clock generator 20 generates an internal clock signal CLK. Control signal (CKE, bCS, bRAS, bCAS, bWE) CMD is input into a control unit (command control) 21 in synchronization with internal clock signal CLK.

The control unit 21 controls the operation of each circuit block inside the memory core 11 and the peripheral circuit 12 based on the control signal CMD.

A first address latch unit 22 latches bank address signal BA[i:0] and row and column address signals A[n:0] from the interface 13 in synchronization with internal clock signal CLK.

When activation signal ACT from the control unit 21 is active, a row decoder 23 selects for read operation one of banks BK0 to BKx inside a memory cell array 27 based on bank address signal BALTC[i:0] and row address signal ALTC[n:0] latched into the first address latch unit 22 and outputs drive signal WL[k:0]-BK0 to drive one of word lines inside the selected bank.

Also, when activation signal ACT from the control unit 21 is active, the row decoder 23 selects for write operation one of banks BK0 to BKx inside the memory cell array 27 based on bank address signal BALTC[i:0] and row address signal ALTC[n:0] latched into the first address latch unit 22 and outputs drive signal WL[k:0]-BKx to drive one of word lines inside the selected bank.

An address counter unit 24 functions as a read address counter. The address counter unit 24 successively generates read column signal ACR[z:0] used in cycles according to the burst length. The address counter unit 24 also generates bank column address signal BACR[i:0].

When, for example, one of read enable signal RENB[x:0] allocated to each bank by the control unit 21 is enabled, the address counter unit 24 generates bank column address signal BACR[i:0] and read column address signal ACR[z:0] based on bank address signal BALTC[i:0] and column address signal ALTC[z:0] latched into the first address latch unit 22.

Bank column address signal BACR[i:0] and read column address signal ACR[z:0] are input an into column decoder 26 to select the memory cell to be read in, for example, first cycle CL1.

When one of read enable signal RENB[x:0] allocated to each bank is enabled, the column decoder 26 outputs column selection signal CSL[j:0]-0 that selects a memory cell inside selected bank BK0 to be read in the case shown, for example, in FIG. 18 based on bank column address signal BACR[i:0] and read column address signal ACR[z:0].

A second address latch unit 25 functions as a write address latch. The second address latch unit 25 latches read column address signal ACR[z:0] generated by the address counter unit 24 in synchronization with internal clock signal CLK in, for example, first cycle CL1.

Also, a second address latch unit 25 latches bank address signal BALTC[i:0] from the first address latch unit 22 in synchronization with internal clock signal CLK in, for example, first cycle CL1.

Then, the second address latch unit 25 outputs bank address signal BALTC[i:0] and read column address signal ACR[z:0] latched in first cycle CL1 as bank column address signal BACW[i:0] and write column address signal ACW[z:0] to select the memory cell to be written to in, for example, second cycle CL2 following first cycle CL1.

Bank column address signal BACW[i:0] and write column address signal ACW[z:0] are input into the column decoder 26. When one of write enable signal WENB[x:0] allocated to each bank is enabled, the column decoder 26 outputs column selection signal CSL[j:0]-x that selects a memory cell inside selected bank BKx to be written to in the case shown, for example, in FIG. 18 based on bank column address signal BACW[i:0] and write column address signal ACW[z:0].

A column selection switch SW is turned on/off by bank column address signal BACR[i:0], BACW[i:0] and column selection signal CSL[j:0]-0, CSL[j:0]-x and a sense amplifier SA functions as a buffer of read data/write data. The column selection switch SW and the sense amplifier SA will be described later.

Then, read data DQt[m:0]-0, DQc[m:0]-0 from, for example, bank (memory cell array) BK0 is input into a read buffer 28-0. Read data DOUTx[m:0] from read the buffer 28-0 is transferred to an output data latch unit 30. The output data latch unit 30 outputs read data DOUT[m:0] outside of the semiconductor memory device through the interface 13 in synchronization with internal clock signal CLK.

For example, write data DIN[m:0] is input into an input data latch unit 31 from outside the semiconductor memory device through the interface 13 in synchronization with internal clock signal CLK. Write data DINx[m:0] from the input data latch unit 31 is transferred to write a buffer 29-x. Write data DQt[m:0]-x, DQc[m:0]-x from write the buffer 29-x is input into bank (memory cell array) BKx.

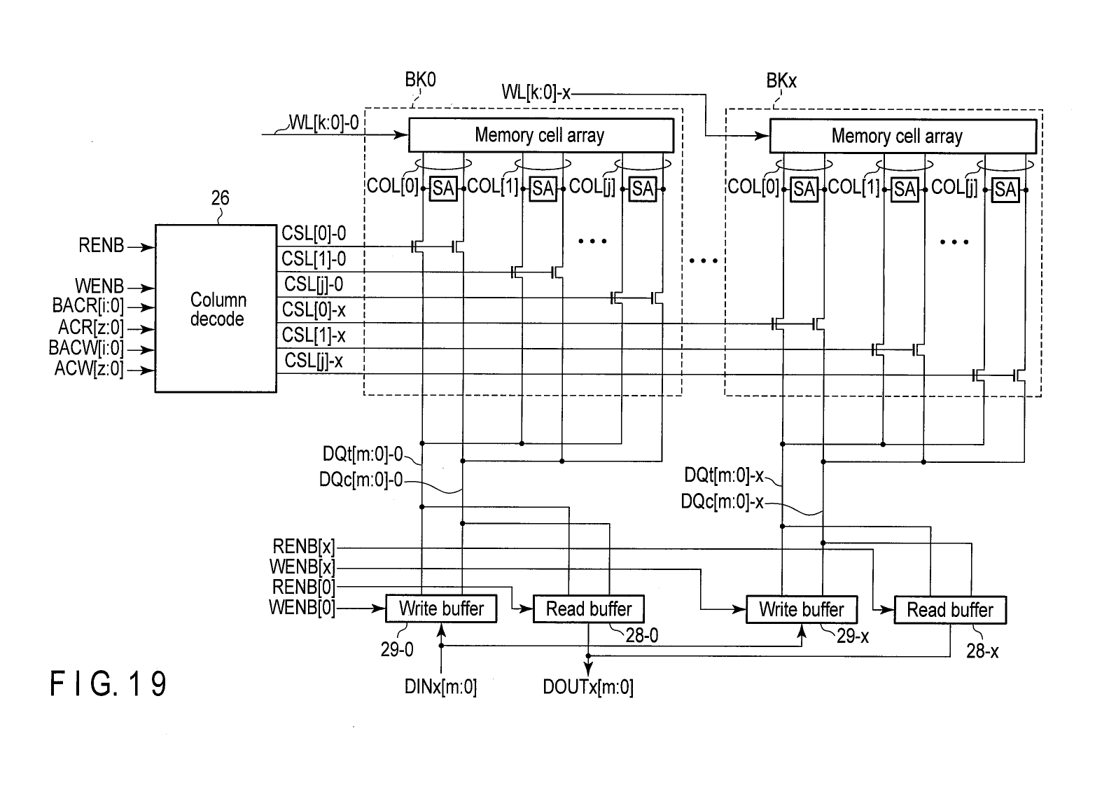

FIG. 19 shows the column selection switch SW and the sense amplifier SA in FIG. 18.

In the present embodiment, the data transfer path between the sense amplifier SA and read/write buffers 28-0, 29-0 inside bank BK0 and the data transfer path between the sense amplifier SA and read/write buffers 28-x, 29-x inside bank BKx are shown.

In the present embodiment, regarding column address COL[0], COL[1], . . . COL[j] inside bank BK0, the sense amplifier SA is commonly connected to the read buffer 28-0 and the write buffer 29-0. Regarding column address COL[0], COL[1], . . . COL[j] inside bank BKx, the sense amplifier SA is commonly connected to the read buffer 28-x and the write buffer 29-x.

That is, at column addresses COL[0], COL[1], . . . COL[j] inside bank BK0, read/write data DQt[m:0]-0, DQc[m:0]-0 is transferred between the sense amplifier SA and read/write buffers 28-0, 29-0.

If, for example, column selection signal CSL[0]-0 is “H” and remaining column selection signals CSL[1]-0, . . . CSL[j]-0 are “L”, read/write data DQt[m:0]-0, DQc[m:0]-0 at column address COL[0] inside bank BK0 is transferred between the sense amplifier SA and read/write buffers 28-0, 29-0.

Similarly, at column addresses COL[0], COL[1], . . . COL[j] inside bank BKx, read/write data DQt[m:0]-x, DQc[m:0]-x is transferred between the sense amplifier SA and read/write buffers 28-x, 29-x.

If, for example, column selection signal CSL[0]-x is “H” and remaining column selection signals CSL[1]-x, . . . CSL[j]-x are “L”, read/write data DQt[m:0]-x, DQc[m:0]-x at column address COL[0] inside bank BKx is transferred between the sense amplifier SA and read/write buffers 28-x, 29-x.

According to the above configuration, because read/write buffers 28-0, 29-0 for bank BK0 and read/write buffers 28-x, 29-x for bank BKx are present, data can be written to column address COL[1] inside bank BK1 from the write buffer 29-x in parallel with reading data from column address COL[1] inside bank BK0 into the read buffer 28-0 in, for example, second cycle CL2 after first cycle CL1.

Specifications in FIG. 15 can thereby be realized.

In the present embodiment, read/write data DQt[m:0]-0, DQc[m:0]-0 is represented as complementary data (2 bits) at column addresses COL[0], COL[1], . . . COL[j] inside bank BK0, but the present embodiment is not limited to such an example.

Also, read/write data DQt[m:0]-x, DQc[m:0]-x is represented as complementary data (2 bits) at column addresses COL[0], COL[1], . . . COL[j] inside bank BKx, but the present embodiment is not limited to such an example.

The read buffer 28-0 is activated when read enable signal RENB[0] is enabled and the write buffer 29-0 is activated when write enable signal WENB[0] is enabled.

Similarly, the read buffer 28-x is activated when read enable signal RENB[x] is enabled and the write buffer 29-x is activated when write enable signal WENB[x] is enabled.

### CONCLUSION

According to an embodiment, throughput can be improved without increasing the chip size and the number of terminals in an interface.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor memory device comprising:
a memory core;
a peripheral circuit which executes a reading/writing of data in the memory core; and
an interface which inputs a control signal for the reading/writing,
wherein the control signal is input through one data path, and
the peripheral circuit is configured to:
read a first data from a first address in the memory core in a first cycle, and
read a second data from a second address in the memory core in parallel with writing a third data to a third address in the memory core in a second cycle.

2. The device of claim 1,
wherein each of the first, second and third addresses includes row and column addresses, and
the row and column addresses of the third address are identical to the row and column addresses of the first address.

3. The device of claim 2,
wherein the row address of the first address and the row address of the second address are identical and the column address of the first address and the column address of the second address are different.

4. The device of claim 3,
wherein the column address of the third address is generated based on the column address of the first address.

5. The device of claim 4,
wherein the peripheral circuit comprising:
a first address latch unit which latches the first address;
an address counter unit which generates the column addresses of the first and second addresses based on the first address in the first address latch unit; and
a second address latch unit which latches the column address of the first address generated by the address counter unit,
wherein the second address latch unit outputs the column address of the first address as the column address of the third address in the second cycle.

6. The device of claim 1,
wherein each of the first, second and third addresses includes row and column addresses, and
the column address of the third address is input from the interface into the peripheral circuit.

7. The device of claim 6,
wherein the peripheral circuit comprising:
an address latch unit which latches the first and third addresses;
a first address counter unit which generates the column addresses of the first and second addresses based on the first address in the address latches unit; and
a second address counter unit which generates the column address of the third address based on the third address in the address latch unit,
wherein the first address counter unit outputs the column address of the second address in the second cycle, and the second address counter unit outputs the column address of the third address in the second cycle.

8. The device of claim 1,
wherein the peripheral circuit includes a control unit which controls the reading/writing, and
the control signal is input into the control unit.

9. The device of claim 8,
wherein each of the first, second and third addresses includes row and column addresses, and
the control signal further instructs one of:
a first mode which generates the column address of the third address based on the column address of the first address, and
a second mode which inputs the column address of the third address from the interface into the peripheral circuit.

10. The device of claim 3, further comprising:
a read buffer and a write buffer commonly connected to the column address of the second address and the column address of the third address; and
a column selection switch which selectively connects the column address of the second address to the read buffer and selectively connects the column address of the third address to the write buffer in the second cycle.

11. The device of claim 3, further comprising:
a first read/write buffer connected to the column address of the second address;
a second read/write buffer connected to the column address of the third address; and
a column selection switch which connects the column address of the second address to the first read/write buffer and connects the column address of the third address to the second read/write buffer in the second cycle.

12. The device of claim 1,
wherein the memory core includes first and second banks, and
the first and second addresses are addresses in the first bank selected by a bank address and the third address is an address in the second bank selected by the bank address.

13. The device of claim 12,
wherein each of the first, second and third addresses includes row and column addresses,
the column address of the third address is identical to the column address of the first address, and
the row address of the first address and the row address of the second address are identical and the column address of the first address and the column address of the second address are different.

14. The device of claim 13,
wherein the peripheral circuit comprising:
a first address latch unit which latches the bank address and the first address;
an address counter unit which generates the column addresses of the first and second addresses based on the first address in the first address latch unit; and
a second address latch unit which latches the column address of the first address generated by the address counter unit,
wherein the second address latch unit outputs the column address of the first address as the column address of the third address in the second cycle.

15. The device of claim 3,
wherein the second cycle is a cycle following the first cycle.

16. The device of claim 15,
wherein the column address of the second address is an address obtained by adding 1 to the column address of the first address.

17. The device of claim 3,
wherein the second cycle is an n-th (n is a natural number equal to 2 or greater) cycle from the first cycle.

18. The device of claim 17,
wherein the column address of the second address is an address obtained by adding n−1 to the column address of the first address.

19. The device of claim 17,
wherein the peripheral circuit includes a write latency control unit, and
a value of n is controlled by the write latency control unit.

20. The device of claim 1,
wherein the first data is output from the interface in an m-th (m is a natural number equal to 2 or greater) cycle from the first cycle and the second data is output from the interface in the m-th cycle from the second cycle.
